(19) United States
(12) Patent Application Publication
(10) Pub. No.: US 2014/0333634 A1
(43) Pub. Date: Nov. 13, 2014

(54) IMAGE PROCESSING APPARATUS AND IMAGE PROCESSING METHOD

(71) Applicant: Yoshimichi KANDA, Kanagawa (JP)

(72) Inventor: Yoshimichi KANDA, Kanagawa (JP)

(21) Appl. No.: 14/263,301

(22) Filed: Apr. 28, 2014

(30) Foreign Application Priority Data
May 10, 2013 (JP) 2013-100698

(51) Int. Cl. G06T 1/20; G06T 1/60

(52) U.S. Cl. CPC G06T 1/20; G06T 1/60
USPC 345/503

(57) ABSTRACT

An image processing apparatus and an image processing method are provided. Each of the image processing apparatus and the image processing method sets to a first setting data storage area an address enabling an access, for each one of sets of application software, to an address window in memory space accessible by a first processor, sets to a second setting data storage area an address of an address window in memory space of a second memory, for each one of the sets of application software, and transfers image data drawn on a first memory to the second memory via an address window specified by the application software, where the first setting data storage area and the second setting memory are included in a second processor and provided for each one of the sets of application software.

### CROSS-REFERENCE TO RELATED APPLICATION

This patent application is based on and claims priority pursuant to 35 U.S.C. §119(a) to Japanese Patent Application No. 2013-100698, filed on May 10, 2013, in the Japan Patent Office, the entire disclosure of which is hereby incorporated by reference herein.

### BACKGROUND

1. Technical Field

Example embodiments of the present invention generally relate to an image processing apparatus and an image processing method.

2. Background Art

An image processing controller includes a central processing unit (CPU), a memory connected to the CPU that stores the image data generated by the CPU, a controller application-specific-integrated-circuit (ASIC) connected between a print engine and the CPU via external interfaces, and a memory connected to the controller ASIC that stores the image data generated by the controller ASIC and the image data input from the print engine.

In some image processing controllers, the load of drawing graphics is shared between the CPU and a graphics accelerator integrated in the controller ASIC. The graphics accelerator is implemented by hardware.

In other words, when the graphics accelerator cannot draw graphics according to particular commands, the CPU draws such graphics on a memory on the CPU side, and transfers the image data to a memory on the controller ASIC side via address windows accessible by an external interface such as a peripheral component interconnect express (PCIe) (registered trademark). Accordingly, the image data generated by the CPU is added to the image data generated by the graphics accelerator. When image data such as page numbers are to be added to the image data input from an engine, the CPU draws such image data as page numbers on a memory on the CPU side, and transfers the image data to a memory on the controller side. Accordingly, the image data generated by the CPU is added to the image data generated by the graphics accelerator.

### SUMMARY

Embodiments of the present invention described herein provide an image processing apparatus and an image processing method. The an image processing apparatus includes a first processor to perform drawing under control of at least one of a plurality of sets of application software, a second processor to perform drawing under control of hardware, a first memory arranged on the first processor side, a second memory arranged on the second processor side, and a setting data storage area to store setting data of an address window configured by the first processor under control of at least one of the sets of application software, the setting data storage area being included in the second processor and provided for each one of the sets of application software, where the first processor transfers image data drawn on the first memory by the first processor to the second memory via the address window. The image processing method includes setting to a first setting data storage area an address enabling an access, for each one of sets of application software, to an address window in memory space accessible by a first processor, setting to a second setting data storage area an address of an address window in memory space of a second memory, for each one of the sets of application software, and transferring image data drawn on a first memory to the second memory via the address window specified by the application software.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a block diagram illustrating the hardware configuration of an image processing apparatus according to an example embodiment of the present invention.

FIG. 2 illustrates the flow of image data in the first set of processes performed by a controller that is one example of an image processing apparatus, according to an example embodiment of the present invention.

FIG. 3 is a flowchart illustrating operation of controlling the first set of processes illustrated in FIG. 2, performed by a CPU, according to an example embodiment of the present invention.

FIG. 4 illustrates the flow of image data in the second set of processes performed by a controller that is one example of an image processing apparatus, according to an example embodiment of the present invention.

FIG. 5 is a flowchart illustrating operation of controlling the second set of processes illustrated in FIG. 4, performed by a CPU.

FIG. 6 illustrates address windows in the memory space of a memory on a controller ASIC side, in an image processing apparatus according to an example embodiment of the present invention.

FIGS. 7A and 7B illustrate base address registers for setting a base address to application-software memory space in the memory space of FIG. 6.

FIGS. 8A and 8B illustrate base-address offset registers for setting an offset for a base address to application-software memory space in the memory space on a controller ASIC side of FIG. 6.

FIG. 9 is a flowchart illustrating operation of transferring image data from a memory on a CPU side to a memory on a controller ASIC side, performed by the CPU, which is a part of the operation illustrated in FIGS. 3 and 5.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more CPUs, digital signal processors (DSPs), ASICs, field programmable gate arrays (FPGAs) computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Example embodiments of the present invention will be described below with reference to the drawings.

<Hardware Configuration of Image Processing Apparatus>

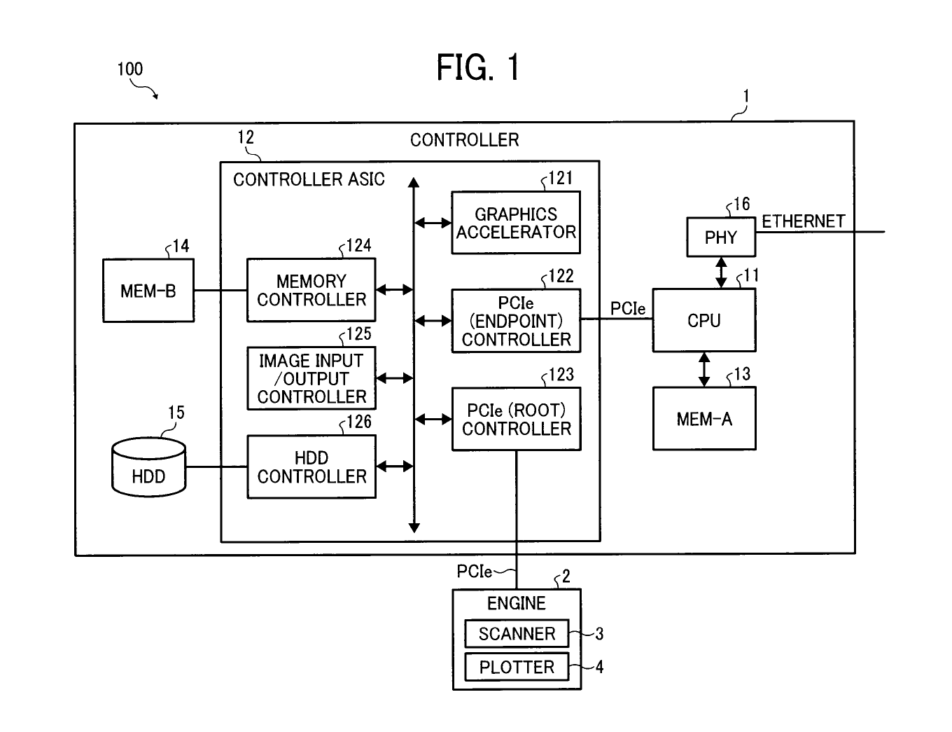

FIG. 1 is a block diagram illustrating the hardware configuration of an image processing apparatus according to an example embodiment of the present invention.

An image forming apparatus 100 includes a controller 1 that serves as an image processing apparatus, and an engine 2 including a scanner 3 and a plotter 4. The controller 1 is connected to the engine 2 via a PCIe. In this example, the controller 1 is a board that controls image processing.

The controller 1 includes a CPU 11, a controller ASIC 12 with graphic-drawing capability, a memory-A (MEM-A) 13 that is a memory on the CPU 11 side, a memory-B (MEM-B) 14 that is a memory on the controller ASIC 12 side, a hard disk drive (HDD) 15, and a physical layer controller (PHY) 16. Note that the CPU 11, the controller ASIC 12, the MEM-A 13, and the MEM-B 14 correspond to a first processor with graphic-drawing capability controlled by application software, a second processor with graphic-drawing capability controlled by hardware, a first memory on the first processor side, and a second memory on the second processor side, respectively, according to an embodiment of the present invention.

The CPU 11 is connected to the controller ASIC 12 via a PCIe interface. Moreover, the MEM-A 13 and the PHY 16 are connected to the CPU 11. The PHY 16 is connected to a network such as a local area network (LAN) through the Ethernet (registered trademark). Note that the PCIe interface may be replaced with a peripheral component interconnect (PCI) interface.

The controller ASIC 12 includes a graphics accelerator 121, a PCIe (endpoint) controller 122, a PCIe (root) controller 123, a memory controller 124, an image input/output controller 125, and a HDD controller 126, and with these devices, performs controlling processes collectively.

The MEM-A 13 is a system memory used by the CPU 11 for plotting. The MEM-B 14 is a local memory storing the image data input from the scanner 3 provided for the image forming apparatus 100 via the controller ASIC 12, or the image data plotted by the graphics accelerator 121. The HDD 15 is a storage area storing image data or a program such as application software.

The CPU 11 is a processor that controls entire operation of the image forming apparatus 100. When the engine 2 of the image forming apparatus 100, the MEM-B 14, and the HDD 15 each of which is connected to the controller ASIC 12 are to be controlled, the CPU 11 controls them via the PCIe (endpoint) controller 122 provided for the controller ASIC 12.

More specifically, when image data is to be input from the scanner 3, the CPU 11 controls the PCIe (root) controller 123 to receive through a PCIe interface the image data input from the scanner 3 provided for the image forming apparatus 100, and controls the memory controller 124 to write the received image data into the MEM-B 14.

When an image is to be output by using copy application or printer application, the CPU 11 controls the memory controller 124 to read image data from the MEM-B 14. Then, the CPU 11 controls the PCIe (root) controller 123 to output the image data to the engine 2 of the image forming apparatus 100. As a result, the image is output to a recording medium such as paper.

When image data is to be generated by using printer application, the CPU 11 receives a drawing command (drawing data used by a printer) that is transferred from the Ethernet (registered trademark) through the PHY 16, and writes the received drawing command into the MEM-A 13.

Next, the CPU 11 activates the graphics accelerator 121 of the controller ASIC 12 to transfer the drawing command stored in the MEM-A 13 to the MEM-B 14. Next, the graphics accelerator 121 reads the drawing command from the MEM-B 14, and draws graphics in the MEM-B 14.

The CPU 11 keeps the drawing command whose graphics cannot be drawn by the graphics accelerator 121, at the MEM-A 13, and draws the graphics of the drawing command in the MEM-A 13. After the graphics are drawn, the CPU 11 transfers the image data drawn in the MEM-A 13 to the MEM-B 14. Accordingly, the image data to be output by a printer becomes complete.

The CPU 11 controls the HDD controller 126 to store temporary image data or frequently-used image data in the HDD 15.

<First Set of Processes Performed by Image Processing Apparatus>

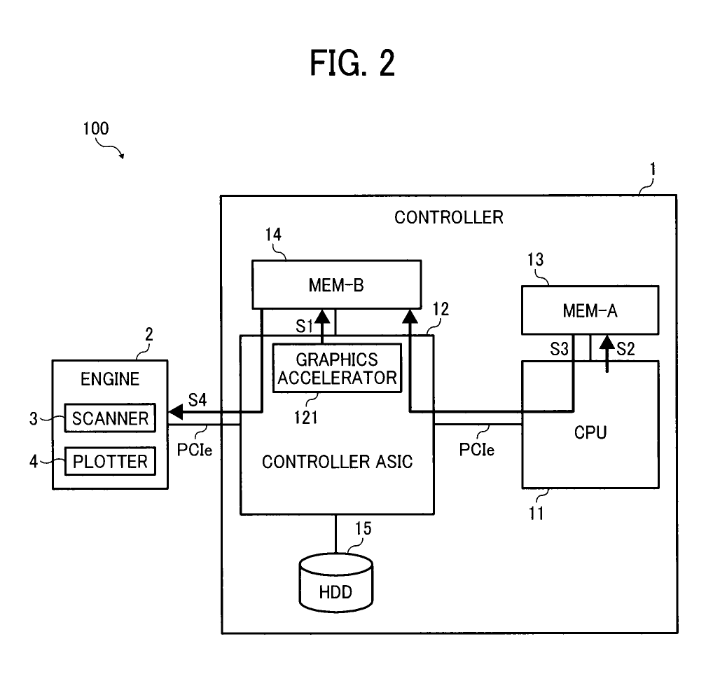

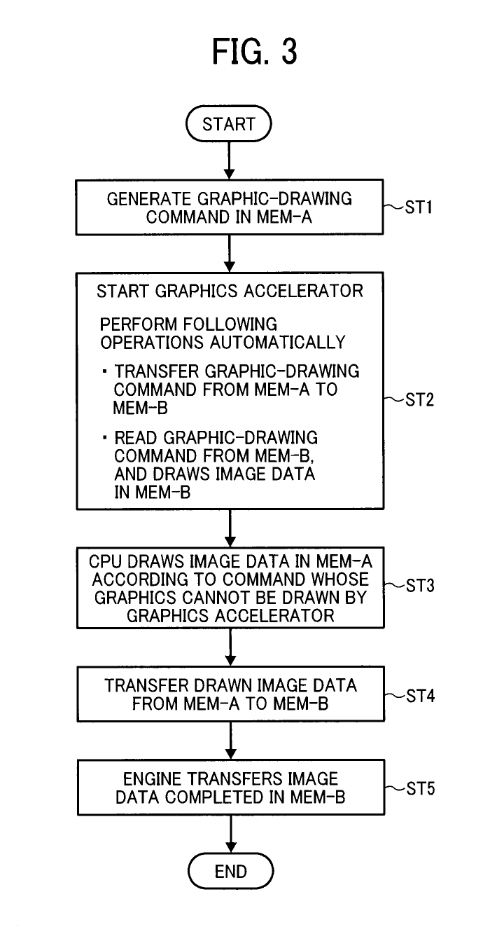

FIG. 2 illustrates the flow of image data in the first set of processes performed by the controller 1 that is one example of an image processing apparatus, according to an example embodiment of the present invention. FIG. 3 is a flowchart illustrating operation of controlling the first set of processes illustrated in FIG. 2, performed by the CPU 11, according to an example embodiment of the present invention. In FIG. 2, like reference signs are given to elements similar to those illustrated in FIG. 1.

The first set of processes relate to operation performed when there are commands whose graphics cannot be drawn by the graphics accelerator 121. The CPU 11 draws graphics instead on the MEM-A 13 on the CPU 11 side, and transfers the drawn graphics to the MEM-B 14 on the controller ASIC 12 side through a PCIe interface. As a result, image data is added and output. In this operation, the CPU 11 performs control operation according to printer application.

Firstly, the CPU 11 generates a graphic-drawing command in the MEM-A 13 (step ST1 in FIG. 3). Next, the CPU 11 activates the graphics accelerator 121 of the controller ASIC 12 (step ST2).

When the graphics accelerator 121 is activated by the CPU 11, a graphic-drawing command is transferred from the MEM-A 13 to the MEM-B 14. After the graphic-drawing command is transferred to the MEM-B 14, a graphic-drawing command is read from the MEM-B 14, and image data is drawn on the MEM-B 14 (automatic execution of step ST2 in FIG. 3, and step S1 in FIG. 2).

The CPU 11 distinguishes a command whose graphics cannot be drawn by the graphics accelerator 121, and draws image data on the MEM-A 13 according to the distinguished graphic-drawing command (step ST3 in FIG. 3, and step S2 in FIG. 2). Next, the CPU 11 transfers the drawn image data from the MEM-A 13 to the MEM-B 14 (step ST4 in FIG. 3, and step S3 in FIG. 2).

The image data drawn by the CPU 11 is added to the image data in the MEM-B 14 drawn by the graphics accelerator 121. When drawing of the image data is complete, the CPU 11 notifies the engine 2 of the completion. When notification is received from the CPU 11, the engine 2 reads the image data from the MEM-B 14, and performs printing (step ST5 in FIG. 3, and step S4 in FIG. 2).

<Second Set of Processes Performed by Image Processing Apparatus>

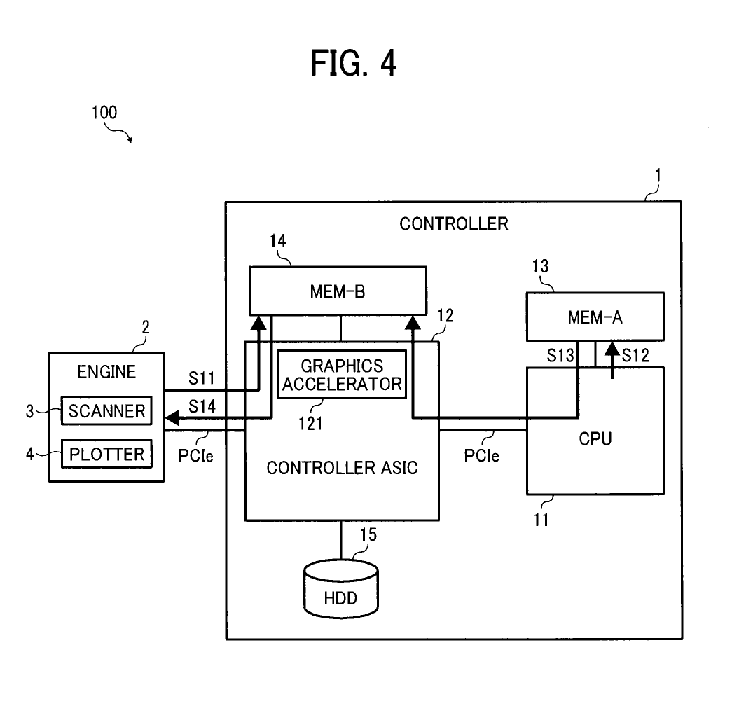

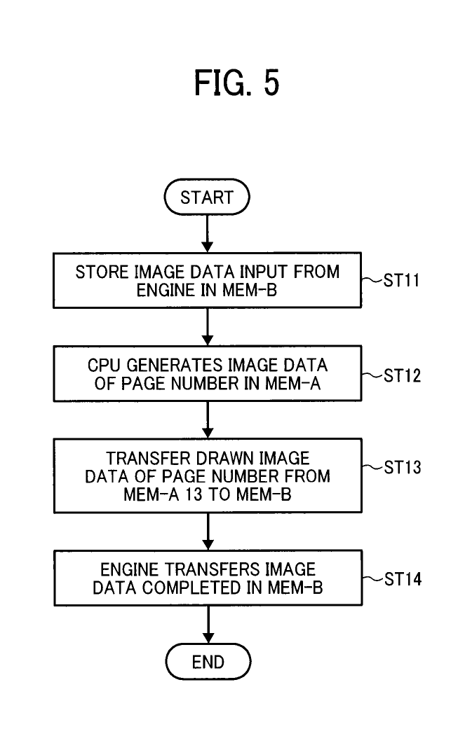

FIG. 4 illustrates the flow of image data in the second set of processes performed by the controller 1 that is one example of an image processing apparatus, according to an example embodiment of the present invention. FIG. 5 is a flowchart illustrating operation of controlling the second set of processes illustrated in FIG. 4, performed by the CPU 11. In FIG. 4, like reference signs are given to elements similar to those illustrated in FIG. 2. The second set of processes relate to operation performed when the CPU 11 draws image data of page numbers, which correspond to the image data input from the scanner 3 of the engine 2 to the MEM-B 14 on the controller ASIC 12 side, on the MEM-A 13 on the CPU 11 side, and transfers the drawn image data to the MEM-B 14 on the controller ASIC 12 side through a PCIe interface. As a result, image data is added and output. In this operation, the CPU 11 performs control operation according to copy application.

The image data input from the scanner 3 of the engine 2 is transferred to the MEM-B 14, and is stored (step ST11 in FIG. 5, and step S11 in FIG. 4). When the engine 2 has transferred all the image data, the engine 2 notifies the CPU 11 of the completion.

When notification is received from the engine 2, the CPU 11 generates the image data of page number in the MEM-A 13 (step ST12 in FIG. 5, and step S12 in FIG. 4). Next, the CPU 11 transfers the image data of page number drawn in the MEM-A 13 from the MEM-A 13 to the MEM-B 14 (step ST13 in FIG. 5, and step S13 in FIG. 4).

When the image data to which the page number is added becomes complete in the MEM-B 14, the CPU 11 notifies the engine 2 of the completion. When notification is received from the CPU 11, the engine 2 reads the image data from the MEM-B 14, and performs printing (step ST14 in FIG. 5, and step S14 in FIG. 4).

<Address Window of Memory Space of MEM-B 14>

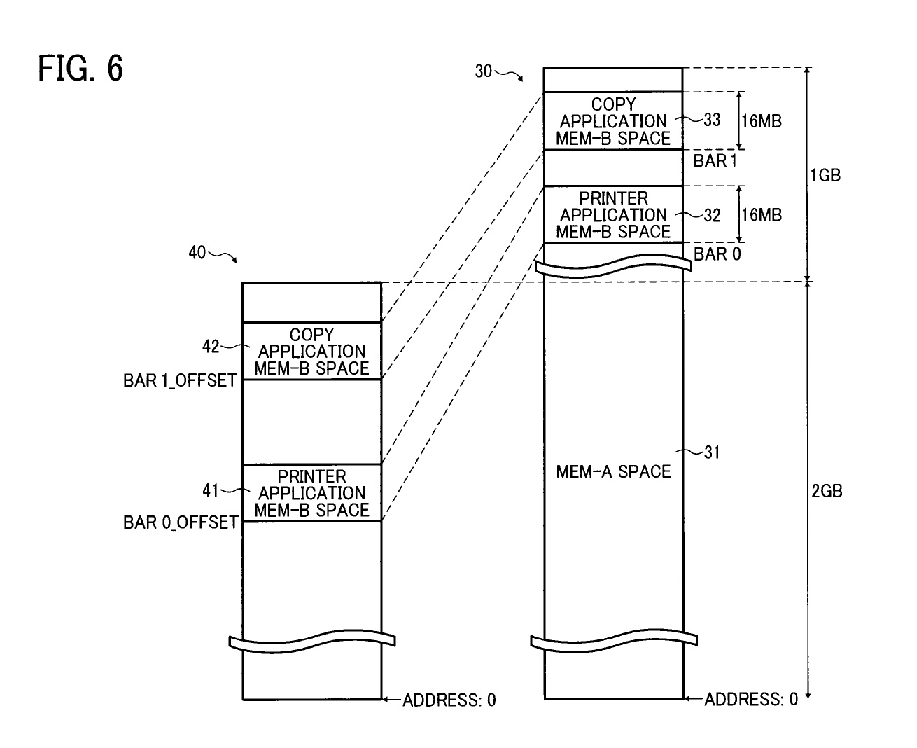

FIG. 6 illustrates address windows in the memory space (storage space) of the MEM-B 14 on the controller ASIC 12 side, according to an example embodiment of the present invention.

Memory space 30 is managed by an OS, and 2 GB of the memory space 30 starting from address 0 is allocated for MEM-A space 31. The MEM-A space 31 is the memory space for the MEM-A 13 on the CPU 11 side, and the memory space 30 is accessible by the CPU 11.

16 MB printer-application MEM-B space 32 and 16 MB copy-application MEM-B space 33 are allocated in 1 GB memory space of the memory space 30 from which the MEM-A space 31 is excluded, for enabling an access to the MEM-B 14 via address windows. In other words, each of the printer-application MEM-B space 32 and the copy-application MEM-B space 33 is independently accessible by a different set of application software.

The base addresses of the printer-application MEM-B space 32 and the copy-application MEM-B space 33 are referred to as base address 0 (BAR0) and base address 1 (BAR1), respectively. At the time of initialization performed when the image forming apparatus 100 is turned on, the CPU 11 sets base address registers of the PCIe of the controller ASIC 12 on the CPU 11 side to BAR0 and BAR1. The base address registers are registers included in the configuration registers of the PCIe. The base address registers are included in a configuration register of the PCIe of the controller ASIC 12. The base address registers are described later.

In the memory space 40 of the MEM-B 14, printer-application MEM-B space 41 and copy-application MEM-B space 42 that correspond to the printer-application MEM-B space 32 and the copy-application MEM-B space 33 are allocated as address windows that are independently accessible by each set of application software.

The addresses of the printer-application MEM-B space 41 and the copy-application MEM-B space 42 are set to base address offset 0 (BAR0_OFFSET) and base address offset 1 (BAR1_OFFSET), which are offset addresses (relative addresses) from address 0, respectively. When image data is transferred by using printer application and copy application via address windows, the CPU 11 sets base-address offset registers of a configuration register to BAR0_OFFSET and BAR1_OFFSET, respectively. The base address offset registers are described later in detail.

The CPU 11 accesses the PCIe to access the printer-application MEM-B space 32 that is set to BAR0. By so doing, the CPU 11 can access the printer-application MEM-B space 41 that is an address window for the printer application of the MEM-B 14. In a similar manner to the above, the CPU 11 accesses the PCIe to access the copy-application MEM-B space 33 that is set to BAR1. By so doing, the CPU 11 can access the copy-application MEM-B space 42 that is an address window for the copy application of the MEM-B 14.

In other words, the address window of BAR0 includes a base address offset register to which BAR0_OFFSET can be set, and the address window of BAR1 includes a base address offset register to which BAR1_OFFSET can be set. The values for offset addresses of registers may be changed such that the MEM-B 14 can be accessed with a different address window in the memory space 40. The start address of an address window in the MEM-B 14 is determined by “0+offset address”.

In FIG. 6, BAR0 and BAR0_OFFSET are used for printer application, and BAR1 and BAR1_OFFSET are used for copy application. However, they may be configured oppositely. Moreover, three or more base addresses and base address offsets may be used such that three or more sets of application software can set address windows.

<Base Address Registers and Base Address Offset Registers>

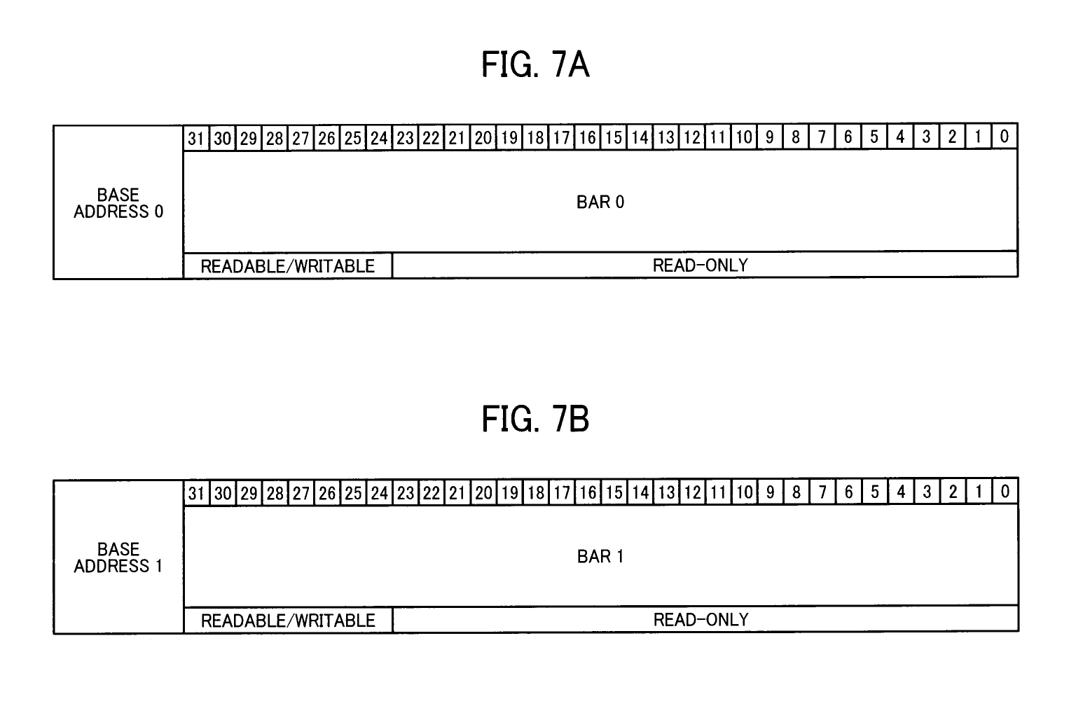

FIGS. 7A and 7B illustrate base address registers for setting a base address to application-software memory space in the memory space 30 of FIG. 6. Here, FIG. 7A depicts a base address register for setting BAR0, and FIG. 7B depicts a base address register for setting BAR1.

Base address registers that serve as the first setting data storage area are a part of a configuration register of the PCIe on the CPU 11 side of the controller ASIC 12. That is, such base address registers are a part of a configuration register of the PCIe (endpoint) controller 122 of FIG. 1.

Each of these base address registers involves 32-bit address space in which higher-order 8 bits are readable/writable and lower-order 24 bits are read-only. Accordingly, the boundary can be set to 16 MB.

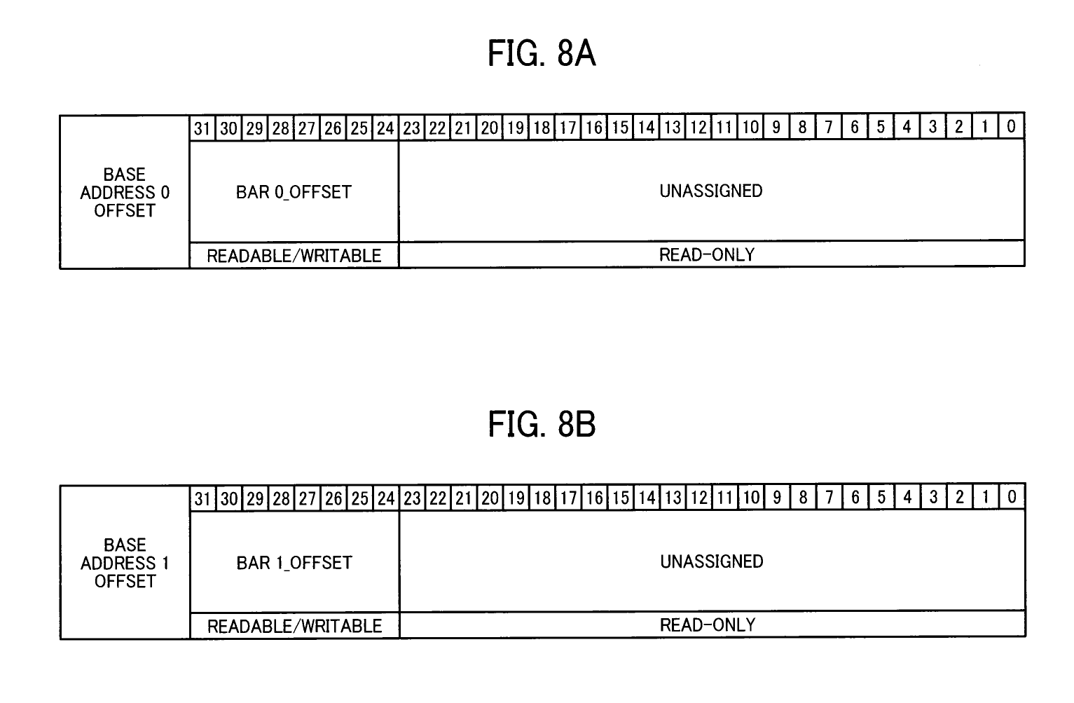

FIGS. 8A and 8B illustrate base-address offset registers for setting an offset for a base address to application-software memory space in the memory space 40 on the controller ASIC 12 side of FIG. 6. Here, FIG. 8A depicts a base-address offset register for setting BAR0_OFFSET, and FIG. 8B depicts a base-address offset register for setting BAR1_OFFSET.

In a similar manner to the base address registers depicted in FIGS. 7A and 7B, each of these base-address offset registers that serve as the second setting data storage area involves 32-bit address space in which higher-order 8 bits are readable/writable and lower-order 24 bits are read-only. Note that these base-address offset registers are also a part of a configuration register of the PCIe (endpoint) controller 122 of FIG. 1.

<Transfer of Image Data from Memory on CPU Side to Memory on Controller ASIC Side>

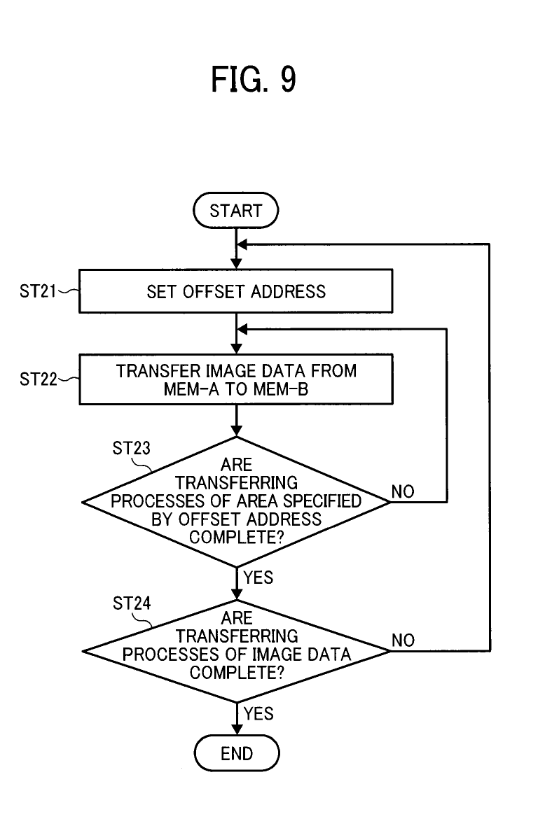

FIG. 9 is a flowchart illustrating operation of transferring image data from the memory on the CPU 11 side to the memory on the controller ASIC 12 side (see step ST4 in FIG. 3 and step ST13 in FIG. 5), performed by the CPU 11, according to an example embodiment of the present invention.

Firstly, the printer application (see FIG. 3 for its control processes) and the copy application (see FIG. 5 for its control processes), each of which controls the CPU 11, set to the base-address offset registers depicted in FIG. 8 offset addresses BAR0_OFFSET and BAR1_OFFSET, which are set to address windows of the memory space 40 of the MEM-B 14 (step ST21: second setting process). As described above, BAR0 and BAR1 are set in advance in the initialization (first setting process).

The CPU 11 operates according to printer application and copy application to serve as a transferring unit. More specifically, the CPU 11 accesses the printer-application MEM-B space 32 and the copy-application MEM-B space 33, respectively, to transfer the image data stored in the MEM-A 12. As a result, the image data is transferred to address windows (i.e., the printer-application MEM-B space 41 and the copy-application MEM-B space 42) of the memory space 40 of the MEM-B 14 (step ST22: transferring process).

After the image data is transferred, whether or not the transferring processes of the area specified by offset addresses is complete, i.e., whether or not all the image data has been transferred to the address window specified by offset addresses, is determined (step ST23 in FIG. 9).

When it is determined that all the image data has not yet been transferred (“NO” in step ST23), the transferring process is continued (step ST22). When it is determined that all the image data in address windows has been transferred (“YES” in step ST23), whether or not all the image data has been transferred from the MEM-A 13 to the MEM-B 14 is determined (step ST24).

When it is determined that not all the image data has been transferred (“NO” in step ST24), next offset addresses of address windows are set to base-address offset registers and further transferring processes are performed (steps ST21 to ST22).

The processes in steps ST21 to ST24 are repeated until all the image data has been transferred from the MEM-A 13 to the MEM-B 14. When all the image data has been transferred (“YES” in step ST24), the processes in the flowchart of FIG. 9 terminate.

Because base-address offset registers are allocated for each set of application software, offset addresses in address windows are not rewritten by another set of application software while controlling processes are performed. Moreover, it is not necessary to share control data among different sets of application software because hardware configuration in which the setting data of address windows are not rewritten by another set of application software is provided.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. An image processing apparatus comprising:
a first processor to perform drawing under control of at least one of a plurality of sets of application software;
a second processor to perform drawing under control of hardware;
a first memory arranged on the first processor side;
a second memory arranged on the second processor side; and
a setting data storage area to store setting data of an address window configured by the first processor under control of at least one of the sets of application software, the setting data storage area being included in the second processor and provided for each one of the sets of application software,
wherein the first processor transfers image data drawn on the first memory by the first processor to the second memory via the address window.

2. The image processing apparatus according to claim 1, wherein the setting data storage area includes:
a first setting data storage area to which an address is set enabling an access, for each one of the sets of the application software, to the address window in memory space accessible by the first processor; and
a second setting data storage area to which an address of the address window in memory space of the second memory is set, for each one of the sets of the application software.

3. The image processing apparatus according to claim 1, wherein
the first processor and the second processor are connected to each other via a PCI interface or a PCIe interface, and
the setting data storage area is a configuration register of the PCI interface or the PCIe interface provided for the second processor.

4. An image processing method comprising:
setting to a first setting data storage area an address enabling an access, for each one of sets of application software, to an address window in memory space accessible by a first processor;
setting to a second setting data storage area an address of an address window in memory space of a second memory, for each one of the sets of application software; and
transferring image data drawn on a first memory to the second memory via the address window specified by the application software.
